(19) United States
(12) Patent Application Publication
(10) Pub. No.: US 2013/0112922 A1
(43) Pub. Date: May 9, 2013

(54) Synthesis Gas Generation

(71) Applicants: Roland Thalhammer, Munchen (DE); Florian Hang, Munchen (DE); Dieter Krenz, Munchen (DE)

(72) Inventors: Roland Thalhammer, Munchen (DE); Florian Hang, Munchen (DE); Dieter Krenz, Munchen (DE)

(73) Assignee: LINDE AKTIENGESELLSCHAFT, Munchen (DE)

(21) Appl. No.: 13/521,623

(22) PCT Filed: Jan. 11, 2011
(86) PCT No.: PCT/EP11/00086

§ 371 Date: Jan. 14, 2013

(30) Foreign Application Priority Data
Jan. 15, 2010 (DE) 10 2010 004 710.4

(51) Int. Cl. C01B 3/02

(52) U.S. Cl. CPC C01B 3/02
USPC 252/373

(57) ABSTRACT

The invention relates to a method for generating a CO and an H₂ product fraction, comprising the following steps: a) reforming (A) a hydrocarbon-containing feed flow (1) for generating a CO- and H₂-rich synthesis gas (5), b) adsorptive separation (C) of undesirable constituents, in particular H₂O and CO₂, from the synthesis gas, c) separating (D) the adsorptively treated synthesis gas (7) into a CO product fraction (8) and an H₂-rich fraction (9), wherein the H₂-rich fraction (9) is supplied at least partially and/or at least intermittently to the adsorptive separation unit (C) as a regenerating gas, d) adsorptive hydrogen separation (E) from the H₂-rich fraction (10), wherein the separated hydrogen constitutes the H₂ product fraction, and e) supplying the residual gas fraction (3) from the adsorptive hydrogen separation unit (E) as heating gas to the reformation (A), wherein the reformation process (A) is operated depending on the composition of the residual gas fraction (3) supplied as heating gas to the reformation (A).

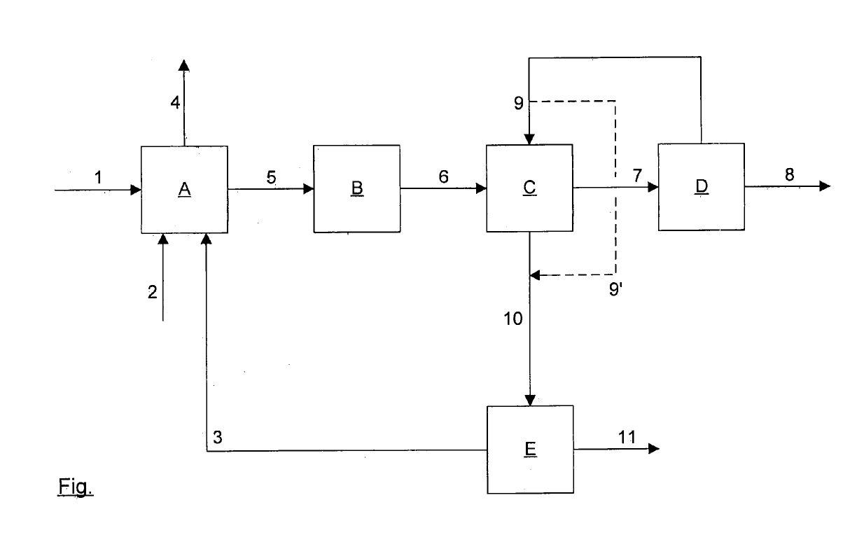

The invention relates to a process for generating CO- and H₂-product fractions, having the following process steps:
a) Reforming a hydrocarbon-containing feedstock stream for generating a CO- and H₂-rich synthetic gas,
b) Adsorptive separation of undesirable components, in particular H₂O and CO₂, from the synthetic gas,
c) Separation of the adsorptively-treated synthetic gas into a CO-product fraction and an H₂-rich fraction, whereby the H₂-rich fraction is fed at least partially and/or at least at times to the adsorptive separating unit as a regeneration gas,
d) Adsorptive hydrogen separation from the H₂-rich fraction, whereby the separated hydrogen represents the H₂-product fraction, and
e) Supply of the residual gas fraction from the adsorptive hydrogen separating unit as a fuel gas for reforming.

A generic process for generating CO- and H₂-product fractions is explained in more detail below based on the embodiment depicted in the FIGURE.

A hydrocarbon-containing feedstock stream 1 as well as a fuel gas fraction 2, which is used to heat the reformer pipe, are fed to a reformer or reforming process A via the lines 1 and 2. In addition, a residual gas fraction is fed to the reformer A via the line 3, which will be explained in greater detail below.

In the reforming A, the hydrocarbon-containing feedstock stream is reacted to form a CO- and H₂-rich synthetic gas that is drawn off via line 5 from the reforming A. An oxygen-containing flue gas is drawn off from the reforming A via line 4.

The CO- and H₂-rich synthetic gas is normally subjected to additional process steps, such as, for example, a CO-shift reaction, CO₂ separation and/or condensate deposition. This or these additional process steps are depicted in the FIGURE by the blackbox B.

Via the line 6, the CO- and H₂-rich synthetic gas is fed to an adsorptive separating unit C that is used for the separation of undesirable components—in particular water, carbon dioxide and methane—from the synthetic gas. The adsorption process that is carried out in this separating unit is a PSA or TSA process; however, combinations of PSA and TSA processes can also be produced.

The synthetic gas that is treated in this way is then fed via the line 7 to a separating process D that preferably operates by rectification, and in the latter is separated into a carbon monoxide product fraction, which is drawn off via the line 8, and a hydrogen-rich fraction.

The latter is fed via the line 9 at least partially and/or at least at times to the already mentioned adsorptive separating unit C as a regeneration gas. Via the bypass line 9′, at least a partial stream of the hydrogen-rich fraction or at least at times the hydrogen-rich fraction can be directed past the adsorptive separating unit C.

The H₂-rich fraction that is used as a regeneration gas is fed via line 10 to an adsorptive hydrogen separation E after passage through the adsorption unit C. In the latter, an H₂-rich fraction, which represents the hydrogen product fraction, is obtained and drawn off via line 11. The residual gas fraction that accumulates in this adsorption process E, which primarily contains water, carbon dioxide, methane and hydrogen, is—as already explained above—fed via the line 3 to the reforming A as an additional fuel gas fraction.

It is problematic in the previously-described process, however, that the components carbon dioxide, carbon monoxide, methane, water, etc., that are adsorbed in the adsorption unit C are extracted from the H₂-rich fraction that is used as a regeneration gas and are fed via line 10 to the adsorptive hydrogen separation E.

While the composition of the H₂-rich fraction 9 that is used as a regeneration gas at the entry into the adsorption unit C is known, it varies at the outlet of the adsorption unit C during the regeneration phase(s). Since, moreover, the components that are released by the regeneration gas during the regeneration phase(s) are not released simultaneously and constantly, the composition of the regeneration gas 10 that is drawn off from the hydrogen separation E can vary comparatively greatly.

This variation of the composition is extended by the adsorptive hydrogen separation E, which has the result that the composition of the residual gas fraction 3 also varies correspondingly over time. The alternating portions of the components, in particular carbon monoxide, carbon dioxide, methane, water and/or hydrogen, in the residual gas fraction 3 cause the heating value of this residual gas fraction to vary. Based on the heating value fluctuations of the residual gas fraction that is fed via line 3 to the reforming A, both temperature fluctuations at the outlet 5 of the reforming A and fluctuations of the oxygen content of the flue gas that is drawn off via line 4 result.

Currently, the changes of the composition of the residual gas fraction 3 that is supplied as a fuel gas are detected only via the control deviations of the reformer outlet temperature and/or the oxygen measurement in the flue gas stream 4. These deviations, however, can reach undesirably high values and can significantly influence the amount and/or composition of the synthetic gas 5 that is generated in the reforming A.

The amount or composition of the synthetic gas that is generated in the reforming A is, however, decisively responsible for the amounts and compositions of the CO-product fraction 8, the H₂-product fraction 11, as well as the residual gas fraction 3 that is fed to the reforming A as a fuel gas. Thus, amount and composition of the synthetic gas 5 that is generated in the reforming A influence all process steps B to E arranged downstream from the reforming A.

The object of this invention is to indicate a generic process for generating CO- and H₂-product fractions, which avoids the above-described drawbacks.

To achieve this object, a process for generating CO- and H₂-product fractions is proposed, which is characterized in that the reforming process is operated based on the composition of the residual gas fraction that is fed to the reforming as a fuel gas.

Additional advantageous configurations of the process according to the invention for generating CO- and H₂-product fractions, which represent subjects of the dependent claims, are characterized in that:
If at least one additional fuel gas fraction is fed to the reforming in addition to the residual gas fraction, characterized in that the heating value of the fuel gas fraction is varied in such a way that the sum of the heating values of the fuel gas fraction and the residual gas fraction is essentially constant,
An adaptation of the reforming process to the fluctuations of the heating value of the residual gas fraction is carried out by the composition and/or the mass flow of the hydrocarbon-containing feedstock stream that is fed to the reforming being varied based on the heating value fluctuation of the residual gas fraction, and
The adsorptive hydrogen separation is operated in such a way that the product quantity and quality of the H₂-product fraction is essentially constant.

According to the invention, the reforming process is now operated based on the composition of the residual gas fraction that is fed to the reforming as a fuel gas.

To this end, it is necessary to estimate in advance as exactly as possible the changes of the heating value of the residual gas fraction that is fed to the reforming as a fuel gas so that based on the actual heating value of the residual gas fraction in each case, a variation of the reforming process is carried out, which ensures that the fluctuations of the composition of the synthetic gas that is generated in the reforming A and/or the oxygen content in the flue gas stream are minimized.

To achieve this, for example in the case of a reduction of the heating value of the residual gas fraction 3, the composition of the fuel gas fraction that is fed via line 2 to the reforming A is changed in such a way that the heating value thereof is increased to the extent that the sum of the heating values of the fuel gas fraction 2 and the residual gas fraction 3 are essentially unchanged over time.

As an alternative to this, an adaptation of the reforming process A to the fluctuations of the heating value of the residual gas fraction 3 can be carried out by, for example, the composition and/or the mass flow of the hydrocarbon-containing feedstock stream 1 that is fed to the reforming A being varied based on the heating value fluctuation of the residual gas fraction 3.

According to an additional advantageous configuration of the process according to the invention for generating CO- and H₂-product fractions, the adsorptive hydrogen separation is operated in such a way that the product quantity and quality of the H₂-product fraction 11 is essentially constant.

The procedure according to the invention for generating CO- and H₂-product fractions now makes possible a stable process or plant operation so that based on the associated low control deviations, minimal fluctuations of the composition of the synthetic gas generated in the reforming A as well as the oxygen content in the flue gas stream can be ensured. As a result of this, only slight fluctuations are produced relative to the CO- and H₂-product fractions.

1. Process for generating CO- and H₂-product fractions, having the following process steps:
a) Reforming (A) a hydrocarbon-containing feedstock stream (1) for generating a CO- and H₂-rich synthetic gas (5),
b) Adsorptive separation (C) of undesirable components, in particular H₂O and CO₂, from the synthetic gas,
c) Separation (D) of the adsorptively-treated synthetic gas (7) into a CO-product fraction (8) and an H₂-rich fraction (9), whereby the H₂-rich fraction (9) is fed at least partially and/or at least at times to the adsorptive separating unit (C) as a regeneration gas,
d) Adsorptive hydrogen separation (E) from the H₂-rich fraction (10), whereby the separated hydrogen represents the H₂-product fraction (11), and
e) Supply of the residual gas fraction (3) from the adsorptive hydrogen separating unit (E) as a fuel gas for reforming (A),
characterized in that the reforming process (A) is operated based on the composition of the residual gas fraction (3) that is fed to the reforming (A) as a fuel gas.

2. Process according to claim 1, whereby at least one additional fuel gas fraction (2) is fed to the reforming (A) in addition to the residual gas fraction (3), wherein the heating value of the fuel gas fraction (2) is varied in such a way that the sum of the heating values of the fuel gas fraction (2) and the residual gas fraction (3) is essentially constant.

3. Process according to claim 1, wherein an adaptation of the reforming process (A) to the fluctuations of the heating value of the residual gas fraction (3) is carried out by the composition and/or the mass flow of the hydrocarbon-containing feedstock stream (1) that is fed to the reforming (A) being varied based on the heating-value fluctuation of the residual gas fraction (3).

4. Process according to claim 1, wherein the adsorptive hydrogen separation (E) is operated in such a way that the product quantity and quality of the H₂-product fraction (11) is essentially constant.
